(19) United States
(12) Patent Application Publication
(10) Pub. No.: US 2011/0181548 A1
(43) Pub. Date: Jul. 28, 2011

(54) TOUCH PANEL AND DISPLAY DEVICE USING THE SAME

(76) Inventor: Shinji SEKIGUCHI, Chiba (JP)

(21) Appl. No.: 13/014,088

(22) Filed: Jan. 26, 2011

(30) Foreign Application Priority Data
Jan. 27, 2010 (JP) 2010-015270

(51) Int. Cl. G06F 3/045

(52) U.S. Cl. 345/174

(57) ABSTRACT

Provided is a capacitive coupling type touch panel, including: a plurality of coordinate detection electrodes (XP1, XP2, YP) for detecting X-Y position coordinates; a first substrate including the plurality of coordinate detection electrodes; and a second substrate (6) disposed to be opposed to the first substrate, in which: the capacitive coupling type touch panel further includes, between the first substrate (1) and the second substrate (6): a conductive layer (ZP) having conductivity; a nonconductive layer (8) supporting the conductive layer; a plurality of nonconductive spacers (4) that are formed at intervals in a plane direction of the first substrate and the second substrate; and an elastic layer (5) that is lower in rigidity than the first substrate, the second substrate, and the plurality of nonconductive spacers.

### CROSS-REFERENCE TO RELATED APPLICATION

The present application claims priority from Japanese application JP2010-015270 filed on Jan. 27, 2010, the content of which is hereby incorporated by reference into this application.

### BACKGROUND OF THE INVENTION

1. Field of the Invention

The present invention relates to a touch panel for inputting coordinates on a screen and a display device using the same. In particular, the present invention relates to a touch panel of capacitive coupling type which enables an input using such an insulator as a resin pen, and to a display device using the touch panel.

2. Description of the Related Art

A display device including an input device (hereinafter, also referred to as “touch sensor” or “touch panel”) having an on-screen input function of inputting information to a display screen by a touch operation (contact and press operation, hereinafter, simply referred to as “touch”) with a user's finger or the like is used for mobile electronic devices such as a PDA and a mobile terminal, various home electric appliances, a stationary customer guiding terminal such as an automatic reception machine, and the like. As the input device using the touch, there are known resistance film type of detecting a change in resistance value of a touched portion, capacitive coupling type of detecting a change in capacitance thereof, optical sensor type of detecting a change in amount of light at the portion shielded by the touch, and the like.

The capacitive coupling type has the following advantages when compared with the resistance film type or the optical sensor type. For example, a transmittance of the resistance film type or the optical sensor type is as low as 80%. On the other hand, a transmittance of the capacitive coupling type is as high as about 90%, thereby preventing a reduction in displayed image quality. In the resistance film type, a touch position is detected by mechanical contact to the resistance film, thereby leading to possible deterioration or breakage (crack) of the resistance film. On the other hand, in the capacitive coupling type, there is no mechanical contact such as contact of a detection electrode with another electrode. Thus, the capacitive coupling type is advantageous in durability.

For example, a capacitive coupling type touch panel is disclosed in Japanese Patent Translation Publication No. 2003-511799. In the capacitive coupling type touch panel disclosed therein, a vertical detection electrode (X electrode) and a horizontal detection electrode (Y electrode) are arranged in vertical and horizontal two-dimensional matrix, and a capacitance of each electrode is detected by an input processing part. When a conductor such as a finger touches a surface of the touch panel, the capacitance of each electrode increases. Thus, the input processing part detects the increase to calculate input coordinates based on a signal of a capacitance change detected by each electrode. Even when the detection electrode is deteriorated to change its resistance value as physical characteristics, such an influence on capacitance detection is limited. Thus, there is only a little influence on input position detection accuracy of the touch panel. As a result, high input position detection accuracy may be realized.

Further, Japanese Patent Application Laid-open No. 2004-005672 discloses a touch panel which has a polymeric layer containing conductive particles formed on a surface of a transparent electrode of the touch panel, which produces an excellent effect of attenuating reflections, to thereby improve transparency.

### SUMMARY OF THE INVENTION

However, in the capacitive coupling type touch panel, as disclosed in Japanese Patent Translation Publication No. 2003-511799, the input coordinates are detected by detecting a capacitance change in each electrode for detection, and hence a conductive material is supposed to be used as input means therefor. The conductive material may be typified by a human finger, and the capacitive coupling type touch panel is recognized as a finger input touch panel. Therefore, the capacitive coupling type touch panel has a problem that, in a case where a resin stylus, which is a nonconductive insulator used for a resistive touch panel or the like, is brought into contact with the capacitive coupling type touch panel, the capacitance change hardly occurs in the electrodes, and hence the input coordinates cannot be detected.

Alternatively, in a case where a stylus made of a conductive material such as metal is to be used for making an input to the capacitive coupling type touch panel, the number of electrodes needs to be increased. For example, a consideration is given to a case where a 4-inch capacitive coupling type touch panel with an aspect ratio of 3 to 4 is implemented by a rhombic electrode shape as disclosed in Japanese Patent Translation Publication No. 2003-511799. Here, when the touch panel is intended for a finger input, a smallest contact surface is assumed to be 6 mm in diameter. In order to provide the detection electrodes at intervals based on the diameter, 22 electrodes are necessary in total. On the other hand, a contact surface to be made by the stylus is assumed to be 1 mm in diameter. When the detection electrodes are formed at intervals based on the diameter of 1 mm, the number of the detection electrodes increases about 6-fold to 139. When the number of the electrodes increases, a frame area necessary for installing wiring to the input processing part increases. Further, the number of signal connection lines to a control circuit also increases, which leads to a reduction of reliability against impact or the like. The number of terminals of the input processing part also increases to increase a circuit area, which leads to a fear of cost increase. On the other hand, if a stylus having a tip end formed of a conductive rubber is used, the shape of the stylus needs to be 6 mm in diameter at a contact surface, provided that the number of the electrodes is unchanged, which brings an uncomfortable feeling in inputting characters.

For the above-mentioned reasons, the capacitive coupling type touch panel such as the capacitive coupling type touch panel disclosed in Japanese Patent Translation Publication No. 2003-511799 described above requires measures to deal with an input to be made by an insulating material (measures for stylus input).

In order to solve the above-mentioned problem, a capacitive coupling type touch panel according to the present invention includes: a plurality of coordinate detection electrodes for detecting X-Y position coordinates; a first substrate including the plurality of coordinate detection electrodes; and a second substrate disposed to be opposed to the first substrate, in which the capacitive coupling type touch panel further includes, between the first substrate and the second substrate: a conductive layer having conductivity; a nonconductive layer supporting the conductive layer; a plurality of nonconductive spacers that are formed at intervals in a plane direction of the first substrate and the second substrate; and an elastic layer that is lower in rigidity than the first substrate, the second substrate, and the plurality of nonconductive spacers.

Further, the capacitive coupling type touch panel according to an aspect of the present invention may include a plurality of transparent X electrodes, a plurality of transparent Y electrodes, and a plurality of transparent Z electrodes, in which each of the plurality of X electrodes and each of the plurality of Y electrodes may intersect with each other through a first insulating layer. Further, each of the plurality of X electrodes and each of the plurality of Y electrodes may include pad portions and thin line portions that are formed so as to be alternately arranged in an extending direction of the electrodes, and the pad portions of the plurality of X electrodes and the pad portions of the plurality of Y electrodes may be arranged without overlapping one another in plan view.

Still further, in the capacitive coupling type touch panel according to another aspect of the present invention, each of the plurality of Z electrodes may be arranged via spacers so as to be disposed at a certain distance from each of the plurality of X electrodes and each of the plurality of Y electrodes. In this case, compression that occurs under pressure applied by a touch causes an elastic layer laminated on the plurality of Z electrodes to be deformed along the shape of the spacers. As a result, the distance from the plurality of Z electrodes to the plurality of X electrodes, and the distance from the plurality of Z electrodes to the plurality of Y electrodes are reduced, which increases electrostatic capacitance. Accordingly, even when an input is made with nonconductive input means, the capacitance change occurring between the X electrodes and the Z electrodes, and between the Y electrodes and the Z electrodes (in a portion in which the distance between the electrodes changes by the pressure) may be detected, to thereby identify the coordinates of a touched position.

Still further, in the capacitive coupling type touch panel according to a further aspect of the present invention, a material for forming the Z electrodes may be formed on a thin nonconductive layer and bonded to the elastic layer, with a view toward preventing cracking of the Z electrodes that may occur due to compression that occurs under pressure applied by a touch when a material for forming the Z electrodes is directly formed on the elastic layer.

Still further, in the capacitive coupling type touch panel according to a still further aspect of the present invention, the elastic layer is deformed by compression that occurs under pressure applied by a touch. In a case where pressure is repeatedly applied under a large load (of, for example, equal to or larger than 10 N with a resin pen) when using the touch panel, the elastic layer may be subjected to plastic deformation or displaced from the adjacent layer at an interface therebetween, which leaves an impression of the touch at the touched position. In view of this, the elastic layer may be formed of a plurality of laminated layers that are different from one another in hardness. With this configuration, there may be obtained a touch panel input device which is excellent in durability, in which even a touch made thereto under a large load hardly leaves an impression thereon.

According to the present invention, an insulator such as a resin pen may be used, in addition to a finger, to make an input to a capacitive coupling type touch panel.

### BRIEF DESCRIPTION OF THE DRAWINGS

In the accompanying drawings:

FIG. 1 is a system configuration diagram of an input device and a display device using the same according to a first embodiment of the present invention;

FIG. 2 is a sectional view illustrating an electrode structure of a touch panel according to the first embodiment of the present invention;

FIG. 3 is a plan view illustrating the electrode structure of the touch panel according to the first embodiment of the present invention;

FIG. 4A is a schematic view for illustrating a capacitance change that occurs in the touch panel according to the first embodiment of the present invention when an input is made thereto with a resin pen;

FIG. 4B is a diagram for illustrating a capacitance in the touch panel according to the first embodiment of the present invention when an input is made thereto with a resin pen;

FIG. 4C is a diagram for illustrating a capacitance in the touch panel according to the first embodiment of the present invention when no input is made thereto;

FIG. 5A is a sectional view illustrating a laminated structure of the touch panel and the display device according to the first embodiment of the present invention;

FIG. 5B is a sectional view illustrating a laminated structure of a touch panel and a display device according to a modified example of the first embodiment of the present invention;

FIG. 6 is a sectional view illustrating an electrode structure of a touch panel according to a second embodiment of the present invention;

FIG. 7 is a schematic view for illustrating a capacitance change that occurs in the touch panel according to the second embodiment of the present invention when an input is made thereto with a resin pen;

FIG. 8 is a sectional view illustrating an electrode structure of a touch panel according to a third embodiment of the present invention;

FIG. 9 is a schematic view for illustrating a capacitance change that occurs in the touch panel according to the third embodiment of the present invention when an input is made thereto with a resin pen;

FIG. 10 is a sectional view illustrating an electrode structure of a touch panel according to a fourth embodiment of the present invention;

FIG. 11 is a schematic view for illustrating a capacitance change that occurs in the touch panel according to the fourth embodiment of the present invention when an input is made thereto with a resin pen;

FIG. 12 is a sectional view illustrating an electrode structure of a touch panel according to a fifth embodiment of the present invention;

FIG. 13 is a schematic view for illustrating a capacitance change that occurs in the touch panel according to the fifth embodiment of the present invention when an input is made thereto with a resin pen;

FIG. 14 is a sectional view illustrating an electrode structure of a touch panel according to a sixth embodiment of the present invention;

FIG. 15 is a schematic view for illustrating a capacitance change that occurs in the touch panel according to the sixth embodiment of the present invention when an input is made thereto with a resin pen;

FIG. 16 is a sectional view illustrating an electrode structure of a touch panel according to a seventh embodiment of the present invention;

FIG. 17 is a schematic view for illustrating a capacitance change that occurs in the touch panel according to the seventh embodiment of the present invention when an input is made thereto with a resin pen;

FIG. 18 is a sectional view illustrating an electrode structure of a touch panel according to an eighth embodiment of the present invention; and

FIG. 19 is a schematic view for illustrating a capacitance change that occurs in the touch panel according to the eighth embodiment of the present invention when an input is made thereto with a resin pen.

### DETAILED DESCRIPTION OF THE INVENTION

In the following, embodiments of the present invention are described in detail with reference to the drawings.

### First Embodiment

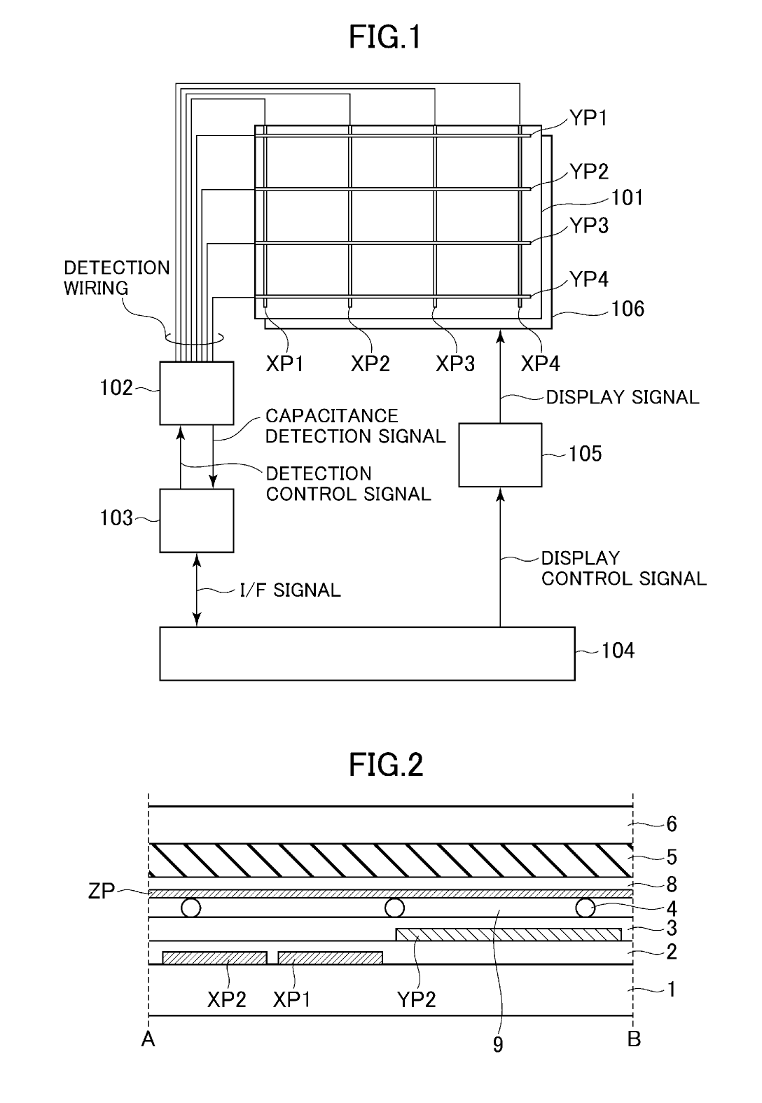

FIG. 1 illustrates a configuration of an input device (hereinafter, referred to as touch panel) according to a first embodiment of the present invention and a display device using the same.

FIG. 1 illustrates a touch panel 101 according to the first embodiment of the present invention. The touch panel 101 includes X electrodes XP for capacitance detection and Y electrodes YP for capacitance detection. The first embodiment is described as an exemplary case where four X electrodes (XP1 to XP4) and four Y electrodes (YP1 to YP4) are provided. However, each of the numbers of the X electrodes XP and the Y electrodes YP is not limited to four.

The touch panel 101 is disposed on a front surface of a display portion 106 of the display device. Accordingly, when an image displayed on the display device is viewed by a user, the image displayed needs to pass through the touch panel 101, and hence the touch panel 101 is expected to have a high transmittance. The X electrodes XP and the Y electrodes YP of the touch panel 101 are connected to a capacitance detection part 102 via detection wiring. The capacitance detection part 102, which is controlled based on a detection control signal output from an arithmetic control part 103, detects a capacitance of each of the electrodes (X electrodes XP, Y electrodes YP) included in the touch panel 101, and outputs, to the arithmetic control part 103, a capacitance detection signal which varies depending on the capacitance value of each electrode. The arithmetic control part 103 calculates, based on the capacitance detection signal for each electrode, a signal component for each electrode, and obtains through calculation the input coordinates based on the signal component for each electrode. When the input coordinates are transferred from the touch panel 101 to a system 104 in response to a touch operation, the system 104 generates a display image corresponding to the touch operation on the touch panel 101, and transfers the display image as a display control signal to a display control circuit 105. The display control circuit 105 generates a display signal, based on the display image transferred as the display control signal, and displays an image on the display device.

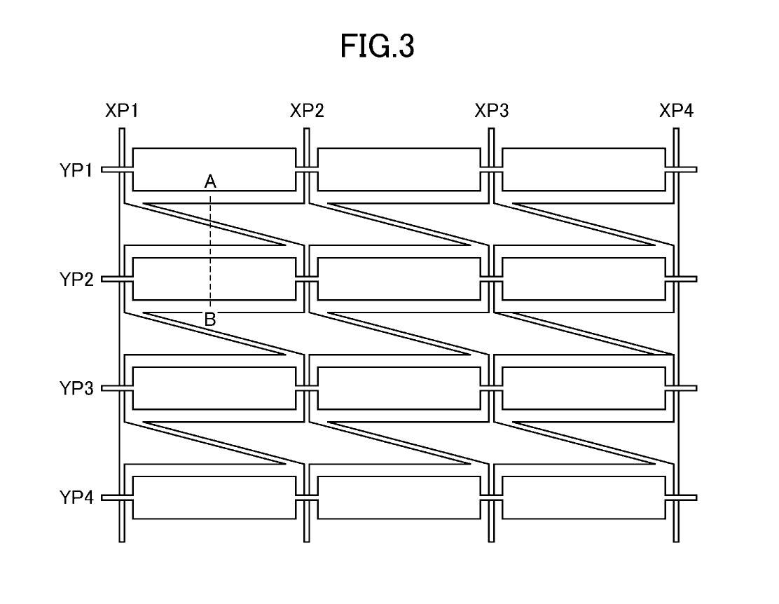

FIG. 2 is a configuration diagram of the touch panel 101 according to the first embodiment of the present invention, which illustrates a cross-sectional shape of the touch panel 101 taken along the line A-B of FIG. 3. The sectional view of FIG. 2 illustrates only the layers that are necessary for describing the operation of the touch panel 101. FIG. 2 illustrates first and second transparent substrates 1 and 6, first and second transparent insulating films 2 and 3, spacers 4, a transparent elastic layer 5, an air layer 9, a nonconductive layer 8, and detection electrodes XP, YP, and ZP.

The touch panel 101 according to the first embodiment of the present invention has a configuration in which the X electrode (transparent conductive film) XP, the first transparent insulating film 2, the Y electrode (transparent conductive film) YP, the second transparent insulating film 3, the nonconductive spacers 4 for providing a space to the Z electrode ZP, the Z electrode ZP which is a conductive layer, the nonconductive layer 8 supporting the Z electrode ZP, and the transparent elastic layer 5 are sequentially laminated on the first transparent substrate 1, with the second transparent substrate 6 being laminated on top thereof. Further, the transparent elastic layer 5 is low in rigidity than the second transparent substrate 6.

FIG. 3 illustrates an electrode pattern of the X electrodes XP and the Y electrodes YP for capacitance detection in the touch panel 101. The X electrodes XP and the Y electrodes YP are connected to the capacitance detection part 102 via the detection wiring. The Y electrodes YP each extend in a lateral direction of the touch panel 101, and a plurality of the Y electrodes YP are arranged in parallel with one another in a longitudinal direction of the touch panel 101. Ata point of intersection between each of the Y electrodes YP and each of the X electrodes XP, the Y electrode YP and the X electrode XP are each reduced in width, to thereby reduce the cross-over capacitance of the electrodes. This point is provisionally referred to as thin line portion. Accordingly, the Y electrodes YP each have the thin line portions and electrode portions (hereinafter, referred to as pad portions) other than the thin line portions, which are alternately arranged in the extending direction thereof. Meanwhile, the X electrodes XP each extend in the longitudinal direction of the touch panel 101, and a plurality of the X electrodes XP are arranged in parallel with one another in the lateral direction of the touch panel 101. Similarly to the Y electrodes YP, the X electrodes XP each have the thin line portions and the pad portions, which are alternately arranged in the extending direction thereof. Each of the X electrodes XP has the pad portions thereof arranged between the adjacent two of the Y electrodes YP.

Next, the shape of the pad portion of the X electrode is described, assuming that a wiring position for connecting the X electrode to the detection wiring (or the thin line portion of the X electrode) is the center of the X electrode in the lateral direction. The pad portion of the X electrode has an electrode shape such that the area thereof becomes smaller as being closer to the center of the adjacent X electrode, while becoming larger as being closer to the center of the X electrode concerned. Therefore, considering an area of the X electrode between two adjacent X electrodes, e.g., an area between XP1 and XP2, the electrode area of the pad portion of the XP1 electrode becomes maximum while the electrode area of the pad portion of the XP2 electrode becomes minimum at the middle portion of the XP1 electrode. In contrast, at the middle portion of the XP2 electrode, the electrode area of the pad portion of the XP1 electrode becomes minimum while the electrode area of the pad portion of the XP2 electrode becomes maximum.

Next, the layer structure of the touch panel 101 is described in order of from the nearest layer to the farthest layer with respect to the first transparent substrate 1. The material, the thickness, and the like to be used for the first transparent substrate 1 are not particularly limited and, depending on the application and use thereof, the first transparent substrate 1 may be formed of a material selected from materials including inorganic glass such as barium borosilicate glass and soda glass, and chemically strengthened glass. The first transparent substrate 1 may preferably be formed in a film thickness of equal to or smaller than 300 μm. Alternatively, a glass film having a film thickness of about 500 μm, on which layers to be described later are formed and laminated, may be combined with a display device, and then subjected to mechanical polishing such as double side polishing or single side polishing using abrasive grain or an abrasive cloth, to thereby form the first transparent substrate 1 in a film thickness of 300 μm. Further, the touch panel 101 may be immersed in a hydrofluoric acid based etchant, so as to form the first transparent substrate 1 in a film thickness of 300 μm.

The first transparent substrate 1 may also be formed of a resin film of a material selected from, for example, polyethersulfone (PES), polysulfone (PSF), polycarbonate (PC), polyarylate (PAR), and polyethylene terephthalate (PET), and the film thickness thereof may be arbitrarily selected as appropriate. Further, the electrodes to be used for XP and YP are a transparent conductive film, which is not particularly limited as long as the electrode is a conductive thin film. Conventional available examples thereof include indium tin oxide (ITO), antimony tin oxide (ATO), and indium zinc oxide (IZO). The transparent conductive film (having a thickness of 50 Å to 200 Å) is formed to have a surface resistance of 500Ω to 2,000Ω, using a sputtering method, and patterning is conducted using an exposure and developing process after application of the resist material. Here, the resist material may be any one of positive and negative type, and an alkaline developable material may be easy to use for forming the resist material. After that, ITO is patterned to be formed by etching. Here, the etchant to be used is preferably selected from an aqueous hydrobromic acid solution or the like.

First, the X electrode XP is formed at a portion close to the first transparent substrate 1, and then the first insulating film 2 for insulating the X electrode XP and the Y electrode YP from each other is formed. Next, the Y electrode YP is formed. Here, the X electrodes XP and the Y electrodes YP may be formed in reverse order. The second insulating film 3 is formed next on the Y electrodes YP, so as to ensure insulation with respect to the Z electrodes ZP to be formed thereon next. The first insulating film 2 and the second insulating film 3 may be varied in film thickness depending on the permittivity of the insulating film material. The first insulating film 2 and the second insulating film 3 may easily be adjusted to have a relative permittivity of 2 to 4, and each may be formed in a film thickness of 1 μm to 20 μm. The insulating film layer may be formed of a material such as an ultraviolet (UV) curable resin material, an alkaline developable insulating film material of negative type or positive type, or a thermosetting resin material curable by heat. Here, the alkaline developable material may be easy to use for forming the insulating film.

The spacers 4 are formed by dispersing, as appropriate, polymeric beads, glass beads, or the like, which are uniform in grain size. The grain size of the beads for defining the space between the second insulating film 3 formed on the first substrate 1 and the Z electrode may be selectively set to fall within a range of 5 μm to 100 μm, and may preferably be in a range of 20 μm to 50 μm. The beads may preferably be dispersed at a density capable of providing a space of equal to or larger than 20 μm and equal to or smaller than 10,000 μm, between the adjacent beads.

The transparent elastic layer 5 is an elastic rubber-like layer, and is not particularly limited as long as it has elasticity. However, a material which is transparent in a visible light range is preferred for the purpose of improving transmittance. Examples of the material include a butyl rubber, a fluorocarbon rubber, an ethylene-propylene-diene monomer rubber (EPDM), an acrylonitrile-butadiene rubber (NBR), a chloroprene rubber (CR), a natural rubber (NR), an isoprene rubber (IR), a styrene-butadiene rubber (SBR), a butadiene rubber, an ethylene-propylene rubber, a silicone rubber, a polyurethane rubber, a polynorbornene rubber, a styrene-butadiene-styrene rubber, an epichlorohydrin rubber, a hydrogenated NBR, a polysulfide rubber, and a urethane rubber. The rubbers may be used alone, or two or more kinds of them may be used in combination. The range of reflection index of rubber or resin described above is preferably between 1. 4 to 1. 8. In order that the rubber or resin be deformed sufficiently by pressure, its film thickness may be thicker than the diameter of the spacer 4, preferably 5 μm or more (which is thicker than the space provided by the spacer 4).

The nonconductive layer 8 may preferably be formed of a transparent resin film of a material selected from, for example, polyethersulfone (PES), polysulfone (PSF), polycarbonate (PC), polyarylate (PAR), and polyethylene terephthalate (PET), in view of visible light transmission. The nonconductive layer 8 is required to be deformed along the shape of the spacers without becoming a hindrance to the elasticity of the transparent elastic layer 5 when pressure is applied thereto through a touch, and hence the nonconductive layer 8 may preferably be in a film thickness of equal to or smaller than 100 μm.

The Z electrode ZP is a transparent conductive film, and is not particularly limited as long as it is a thin film having conductivity, and conventional indium tin oxide (ITO), antimony tin oxide (ATO), and indium zinc oxide (IZO) may be used as a base material to form the thin film with respect to the nonconductive layer 8. The transparent conductive film is formed into a film by a sputtering method so that the surface resistance may be 500Ω to 2,000Ω, and patterned into a shape corresponding to the X and Y electrodes by an exposure and developing process after application of a resist material. In this case, any of a positive-type and a negative-type resist material may be used as the resist material, and an alkaline developable resist material may be readily formed. After that, ITO is patterned by etching. An aqueous hydrobromic acid solution or the like may be selected as the etchant in this case. In addition, when the Z electrode ZP is formed so that the surface resistance may be 10,000Ω to 10,000,000Ω, patterning becomes unnecessary. As a result, in addition to a thin film obtained by dispersing fine particles of conventional indium tin oxide (ITO), antimony tin oxide (ATO), indium zinc oxide (IZO), or the like into a transparent resin, a thin film obtained by dispersing conductive fine particles, for example, metal fine particles made of nickel, gold, silver, copper, or the like, insulating inorganic fine particles, or resin fine particles coated with metal into a resin and the like may be used. Further, fine particles made of at least one kind of metal oxide selected from the group consisting of Al₂O₃, Bi₂O₃, CeO₂, In₂O₃, (In₂O₃.SnO₂), HfO₂, La₂O₃, MgF₂, Sb₂O₅, (Sb₂O₅.SnO₂), SiO₂, SnO₂, TiO₂, Y₂O₃, ZnO, and ZrO, or metal fluoride may be used by dispersing into a transparent resin. In addition, organic conductive materials such as polyaniline, polyacetylene, polyethylene dioxythiophene, polypyrrole, polyisothianaphthene, polyisonaphthothiophene may also be used by being applied. Further, materials having low optical absorption and scattering as a result of optical refractive index and optical reflection are preferred for the Z electrode, and preferably appropriately selected.

The material to be used for the second transparent substrate 6 is not limited to a particular material. However, because it is necessary to transmit the compression force of the pressing to the transparent elastic layer 5, it is possible to select inorganic glass such as barium borosilicate glass or soda glass, or chemically strengthened glass. The film thickness thereof is preferably set to 300 μm or smaller. Alternatively, a glass film having a film thickness of about 500 μm, on which layers to be described later are formed and laminated, may be combined with a display device, and then subjected to mechanical polishing such as double side polishing or single side polishing using abrasive grain or an abrasive cloth, to thereby form the second transparent substrate 6 in a film thickness of 300 μm. Further, the touch panel 101 may be immersed in a hydrofluoric acid based etchant, so as to form the second transparent substrate 6 in a film thickness of 300 μm.

The second transparent substrate 6 may also be formed of a resin film of a material selected from, for example, polyethersulfone (PES), polysulfone (PSF), polycarbonate (PC), polyarylate (PAR), and polyethyleneterephthalate (PET), and the film thickness thereof may be arbitrarily selected as appropriate. In addition, in order to satisfy the above-mentioned elasticity, it is preferable that the thickness of the second transparent substrate 6 be 800 μm or smaller. Further, if a substrate in a thickness equal to or smaller than 100 μm is used as the second transparent substrate 6, the substrate is subject to a large amount of deformation under a heavy load, which leaves the interface between the second transparent substrate 6 and the transparent elastic layer 5 susceptible to peeling. Accordingly, the thickness of the second transparent substrate 6 may preferably be equal to or larger than 100 μm.

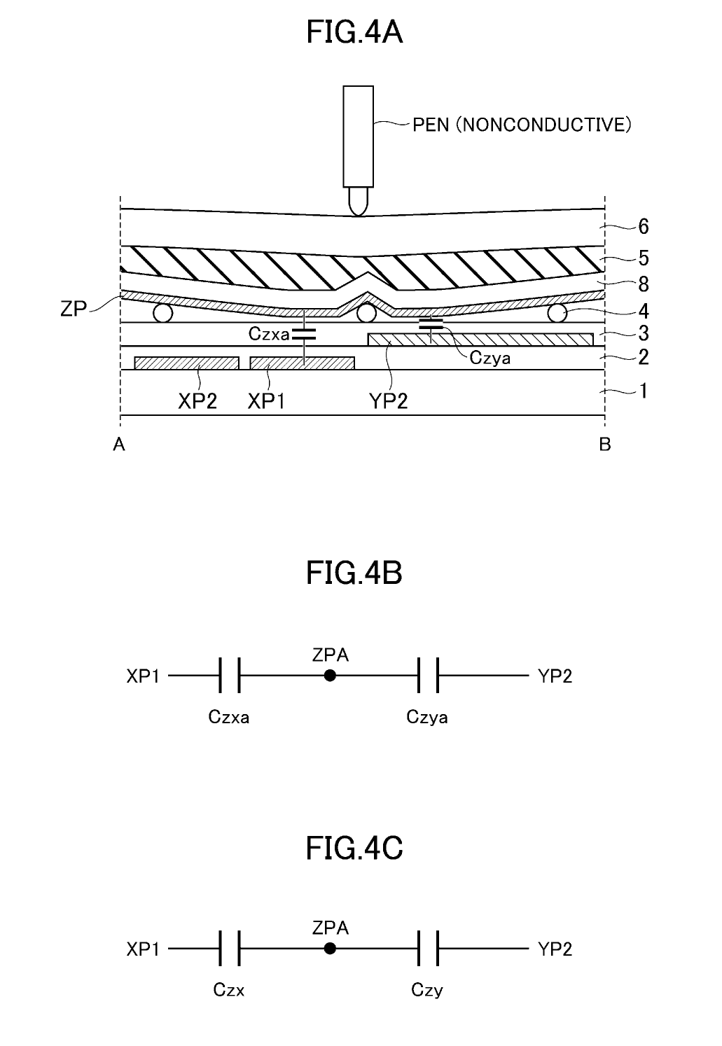

Next, with reference to FIGS. 4A to 4C, a capacitance change that occurs in response to a touch operation made to the touch panel 101 according to the first embodiment of the present invention is described.

FIG. 4A is a schematic view for illustrating a capacitance change that occurs in a case where nonconductive input means is used for making a touch operation, and a distance from the X electrode XP to the Z electrode ZP and a distance from the Y electrode YP to the Z electrode ZP are changed due to a pressure applied when the touch panel 101 is touched. Further, the following description may similarly be applied to a case where the distance from the X electrode XP to the Z electrode ZP and the distance from the Y electrode YP to the Z electrode ZP are changed due to a pressure applied through conductive input means (such as finger).

The capacitance between the X electrode XP and the Y electrode YP adjacent to each other corresponds to an interelectrode capacitance (not shown) between the X electrode and the Y electrode through the insulating film, and a combined capacitance such as a parallel plate capacitance formed by the Z electrode ZP with respect to each of the X electrode XP and the Y electrode YP. Here, a capacitance between the X electrode (XP1) and the Z electrode ZP and a capacitance between the Y electrode (YP2) and the Z electrode ZP without a touch operation are defined as Czx (not shown) and Czy (not shown), respectively. Here, as illustrated in FIG. 4A, in a case where the Z electrode ZP is pressed down due to a pressure applied by a touch, the distances from the Z electrode ZP to each of the X electrode XP and the Y electrode YP are reduced, and hence the parallel plate capacitances thereof increase. Here, when the capacitance between the X electrode XP1 and the Z electrode ZP with a touch operation is defined as Czxa and the capacitance between the Y electrode YP2 and the Z electrode ZP with a touch operation is defined as Czya, these capacitances are expressed by Relational Expressions (1) and (2) below.

Czxa>Czx Expression (1)

Czya>Czy Expression (2)

The Z electrode ZP is a floating electrode, and hence the combined capacitance with a touch operation is assumed to be a series capacitance as illustrated in FIG. 4B. Further, the combined capacitance without a touch operation is assumed to be a series capacitance as illustrated in FIG. 4C. Accordingly, a capacitance change ΔC to occur between the X electrode XP and the Y electrode YP adjacent to each other depending on whether or not a touch operation is made is expressed by Expression (3) below.

{Czxa·Czx·(Czya−Czy)+Czya·Czy·(Czxa−Czx)}/{(Czx+Czy)·(Czxa+Czya)} Expression (3)

The capacitance detection part 102 detects a capacitance of each electrode, or a capacitance change that occurs depending on whether or not a touch operation is made, which is expressed by Expression (3). The arithmetic control part 103 calculates the coordinates of the input when the touch operation is made, by using, as a signal component, the capacitance of each electrode or the capacitance change obtained by the capacitance detection part 102.

According to the description given above, even when the input is made with nonconductive input means, the input coordinates may be detected based on the capacitance change that occurs when the distance from the X electrode XP to the Z electrode ZP and the distance from the Y electrode YP to the Z electrode ZP are changed due to the pressure applied by the input.

In the above, the touch panel 101 according to the first embodiment is described in detail. However, the touch panel 101 according to the first embodiment is not limited to the one illustrated in FIG. 2.

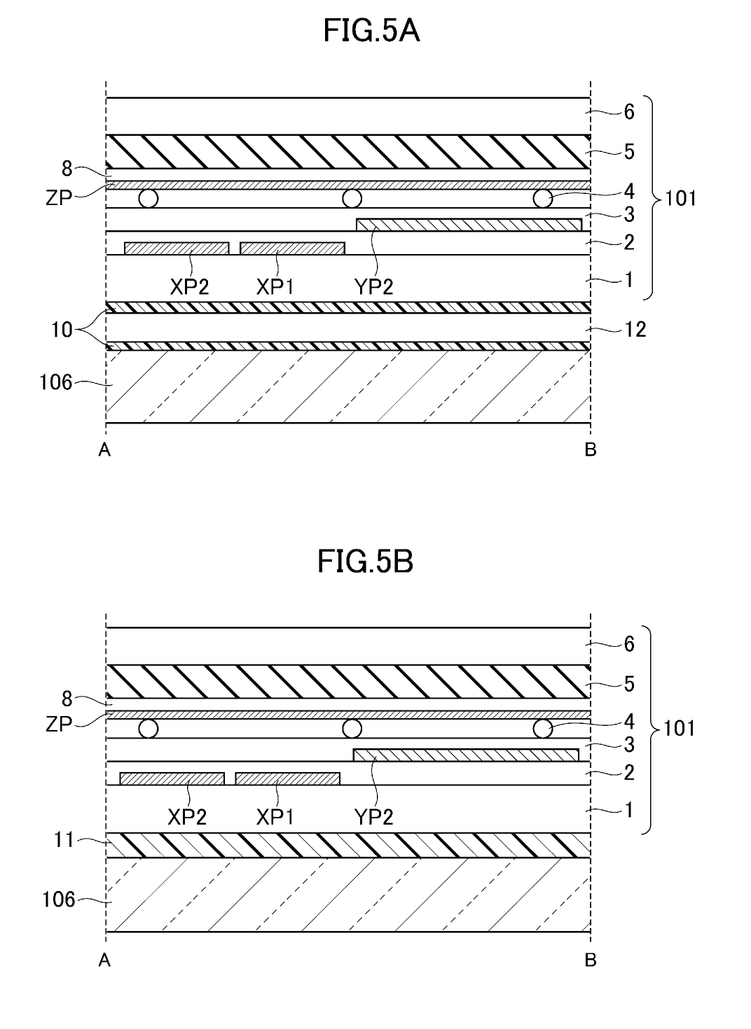

FIG. 5A is a sectional view of the touch panel 101 and the display device 106 according to the first embodiment of the present invention. FIG. 5A illustrates a case in which a space (air layer) 12 is provided between the touch panel 101 and the display device 106. In this case, an antireflective film 10 is formed for preventing reflection occurring at an interface between the air layer 12 and the first transparent substrate 1, and another antireflective film 10 is formed for preventing reflection occurring at an interface between the air layer 12 and the display device 106. Further, a further antireflective film (not shown) may further be formed at an interface between the second transparent substrate 6 and an air layer. With this configuration, the touch panel 101 may further be increased in transmittance, while suppressing external light reflection at the same time. The touch panel 101 and the display device 106 are bonded to each other through the intermediation of a peripheral frame (not shown).

FIG. 5B illustrates a modified example of the first embodiment, illustrating a case where an adhesion layer 11 is used to closely bond the touch panel 101 and the display panel 106. For forming the adhesion layer 11, an adhesive resin material selected from materials in a thickness of equal to or larger than 100 μm in a single layer may be applied, or a resin adhesive sheet selected from resin adhesive sheets in a thickness of equal to or larger than 100 μm in a single layer may be attached. Examples of the adhesive resin material to be applied include a silicone resin, a polyurethane resin, an epoxy resin, a polyester resin, and an acrylic resin. Of those, the acrylic resin having adhesiveness may be preferred in terms of transparency, low cost (high in versatility), and durability, such as heat resistance, moist heat resistance, and light resistance.

The application method for the adhesion layer 11 in this step is not particularly limited as long as the coating solution may be uniformly applied, and methods such as bar coating, blade coating, spin coating, die coating, slit reverse coating, three-roll reverse coating, comma coating, roll coating, and dip coating may be used.

The applied thickness of the adhesion layer 11 in the application step may be 100 μm to 1,500 μm, or more preferably 500 μm to 1,000 μm.

After the above-mentioned application step, in order to polymerize photopolymerizable monomers contained in the above-mentioned resin material coating solution applied by the above-mentioned application step, the photopolymerizable monomers are irradiated with ultraviolet light at an irradiance of 1 mW/cm² or more and less than 100 mW/cm² for 10 to 180 seconds.

Further, in the case of forming the adhesion layer 11 by a sheet-shaped pressure-sensitive adhesive material, examples of the sheet-shaped pressure-sensitive adhesive material having adhesiveness include an acrylic pressure-sensitive adhesive material, a vinyl acetate-based pressure-sensitive adhesive material, a urethane-based pressure-sensitive adhesive material, an epoxy resin, a vinylidene chloride-based resin, a polyamide-based resin, a polyester-based resin, a synthetic rubber-based pressure-sensitive adhesive material, and a silicone-based resin. Of those, the acrylic pressure-sensitive adhesive material and the silicone-based resin, which have high transparency, are preferred. Further, the silicone-based resin is preferred in terms of shock eliminating function.

The adhesion layer 11 eliminates the interfaces between the first transparent substrate 1 and the air layer 12 and between the display device 106 and the air layer 12 in the configuration illustrated in FIG. 5A. In this case, the antireflective film (not shown) may be formed at the interface between the second transparent substrate 6 and the air layer, to thereby increase the transmittance of the touch panel 101 while alleviating external light reflection.

As described above, according to the first embodiment, even when a contact is made onto the touch panel 101 with nonconductive input means, a distance from the X electrode XP or from the Y electrode YP for capacitance detection to the Z electrode ZP formed thereabove is changed, to thereby generate a capacitance change, which allows the touch panel 101 to function as a capacitive coupling type touch panel capable of detecting the input coordinates. Further, even in a case where the touch panel 101 is disposed on the display device 106, an image may be displayed with a high luminance and high contrast.

### Second Embodiment

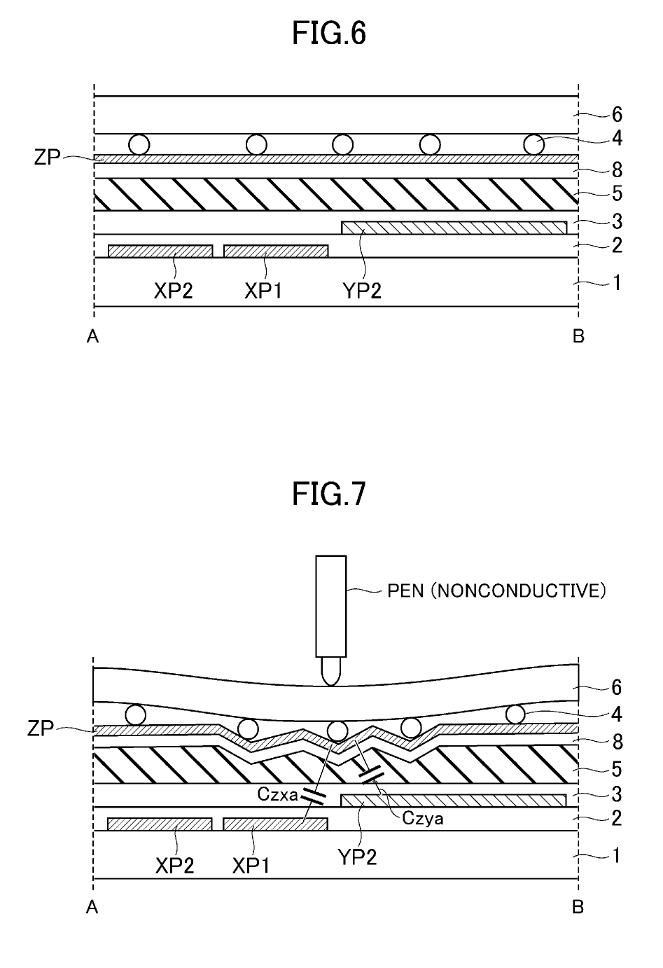

FIG. 6 is a configuration diagram of a touch panel 101 according to a second embodiment of the present invention, which illustrates a cross-sectional shape of the touch panel 101 taken along the line A-B of FIG. 3. The second embodiment is similar to the first embodiment in terms of material and property of each layer, and hence the description thereof is omitted herein.

The touch panel 101 according to the second embodiment of the present invention has a configuration in which the X electrode (transparent conductive film) XP, the first transparent insulating film 2, the Y electrode (transparent conductive film) YP, the second transparent insulating film 3, the transparent elastic layer 5, the nonconductive layer 8, the Z electrode ZP, and the spacers 4 for providing a space with respect to the Z electrode ZP are sequentially laminated on the first transparent substrate 1, with the second transparent substrate 6 being laminated on top thereof.

Next, a capacitance change that occurs in response to a touch operation made to the touch panel 101 according to the second embodiment of the present invention is described with reference to FIG. 7.

FIG. 7 is a schematic view for illustrating a capacitance change that occurs in a case where nonconductive input means is used for making a touch operation, and a distance from the X electrode XP to the Z electrode ZP and a distance from the Y electrode YP to the Z electrode ZP are changed due to a pressure applied when the touch panel 101 is touched. Further, the following description may similarly be applied to a case where the distance from the X electrode XP to the Z electrode ZP and the distance from the Y electrode YP to the Z electrode ZP are changed by a pressure applied through conductive input means (such as finger).

Even in a case where a touch operation is made to the touch panel 101 according to the second embodiment of the present invention, similarly to the first embodiment of the present invention described with reference to FIG. 4, the distances from the Z electrode ZP to each of the X electrode XP and the Y electrode YP are reduced. Accordingly, the capacitance change at this time is expressed by Expression (3) similarly to the first embodiment. The capacitance detection part 102 detects a capacitance of each electrode, or a capacitance change that occurs depending on whether or not a touch operation is made as expressed by Expression (3). The arithmetic control part 103 calculates the coordinates of the input when the touch operation is made, by using, as a signal component, the capacitance of each electrode or the capacitance change obtained by the capacitance detection part 102.

According to the description given above, the input coordinates may be detected based on the capacitance change that occurs when the distance from the X electrode XP to the Z electrode ZP and the distance from the Y electrode YP to the Z electrode ZP are changed due to a pressure, even when the input is made with nonconductive input means.

Further, the display device 106 and the touch panel 101 are laminated in a manner similar to that of the first embodiment of the present invention, and hence the description thereof is omitted herein.

As described above, according to the second embodiment, even when a contact is made onto the touch panel 101 with nonconductive input means, a distance from the X electrode XP or from the Y electrode YP for capacitance detection to the Z electrode ZP formed thereabove is changed, to thereby generate a capacitance change, which allows the touch panel 101 to function as a capacitive coupling type touch panel capable of detecting the input coordinates.

### Third Embodiment

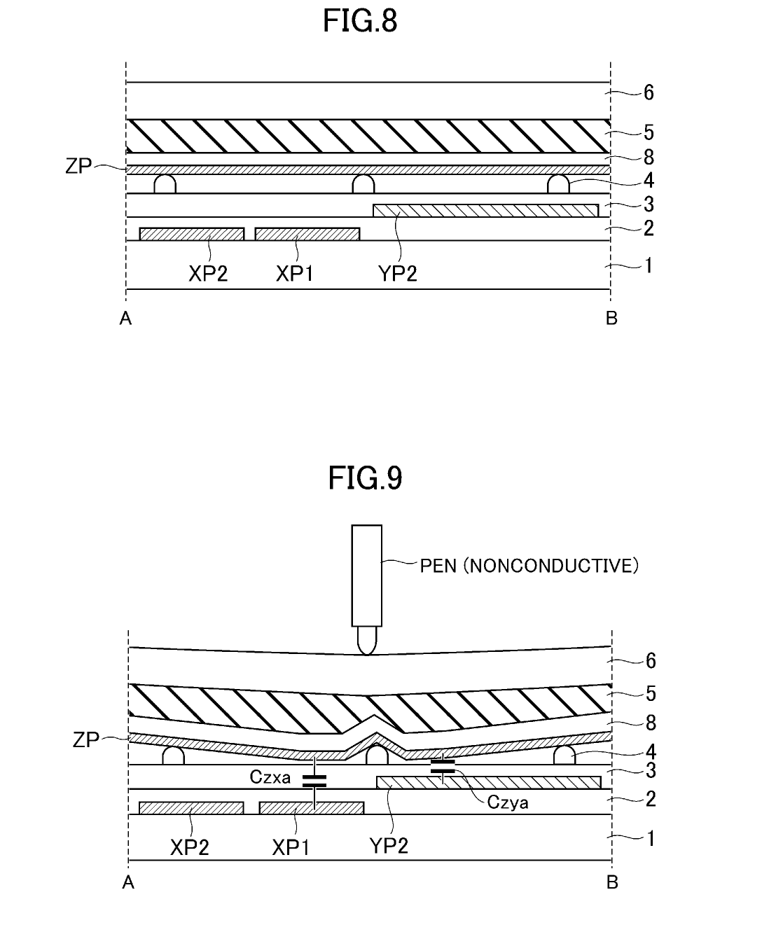

FIG. 8 is a configuration diagram of a touch panel 101 according to a third embodiment of the present invention, which illustrates a cross-sectional shape of the touch panel 101 taken along the line A-B of FIG. 3.

The touch panel 101 according to the third embodiment of the present invention has a configuration in which the X electrode (transparent conductive film) XP, the first transparent insulating film 2, the Y electrode (transparent conductive film) YP, the second transparent insulating film 3, and the spacers 4 for providing a space with respect to the Z electrode ZP, the Z electrode ZP, the nonconductive layer 8, and the transparent elastic layer 5 are sequentially laminated on the first transparent substrate 1, with the second transparent substrate 6 being laminated on top thereof.

The spacers 4 may be formed as dotted columnar spacers which are each made of a photo-curable resin material. The columnar spacers are formed as protrusions protruding from one of the first transparent substrate 1 side and the second transparent substrate 6 side. The columnar spacers may preferably be formed through screen printing or the like at intervals of equal to or larger than 20 μm and equal to or smaller than 10,000 μm. The columnar spacers may be formed in any shape freely selected from, for example, a circular shape and a rectangular shape, and have a diameter falling within a range of 5 μm to 100 μm, which may preferably be in a range of 20 μm to 50 μm.

The third embodiment is similar to the first embodiment in terms of material and property of the other layers, and hence the description thereof is omitted herein.

Next, a capacitance change that occurs in response to a touch operation made to the touch panel 101 according to the third embodiment of the present invention is described with reference to FIG. 9.

FIG. 9 is a schematic view for illustrating a capacitance change that occurs in a case where nonconductive input means is used for making a touch operation, and a distance from the X electrode XP to the Z electrode ZP and a distance from the Y electrode YP to the Z electrode ZP are changed due to a pressure applied when the touch panel 101 is touched. Further, the following description may similarly be applied to a case where the distance from the X electrode XP to the Z electrode ZP and the distance from the Y electrode YP to the Z electrode ZP are changed by a pressure applied through conductive input means (such as finger).

Even in a case where a touch operation is made to the touch panel 101 according to the third embodiment of the present invention, similarly to the first embodiment of the present invention described with reference to FIG. 4, the distances from the Z electrode ZP to each of the X electrode XP and the Y electrode YP are reduced. Accordingly, the capacitance change at this time is expressed by Expression (3) similarly to the first embodiment.

The capacitance detection part 102 detects a capacitance of each electrode, or a capacitance change that occurs depending on whether or not a touch operation is made as expressed by Expression (3). The arithmetic control part 103 calculates the coordinates of the input when the touch operation is made, by using, as a signal component, the capacitance of each electrode or the capacitance change obtained by the capacitance detection part 102.

According to the description given above, the input coordinates may be detected based on the capacitance change that occurs when the distance from the X electrode XP to the Z electrode ZP and the distance from the Y electrode YP to the Z electrode ZP are changed due to a pressure, even when the input is made with nonconductive input means.

Further, the display device 106 and the touch panel 101 are laminated in a manner similar to that of the first embodiment of the present invention, and hence the description thereof is omitted herein.

As described above, according to the third embodiment, even when a contact is made onto the touch panel 101 with nonconductive input means, a distance from the X electrode XP or from the Y electrode YP for capacitance detection to the Z electrode ZP formed thereabove is changed, to thereby generate a capacitance change, which allows the touch panel 101 to function as a capacitive coupling type touch panel capable of detecting the input coordinates. Further, even in a case where the touch panel 101 is disposed on the display device 106, an image may be displayed with a high luminance and high contrast.

### Fourth Embodiment

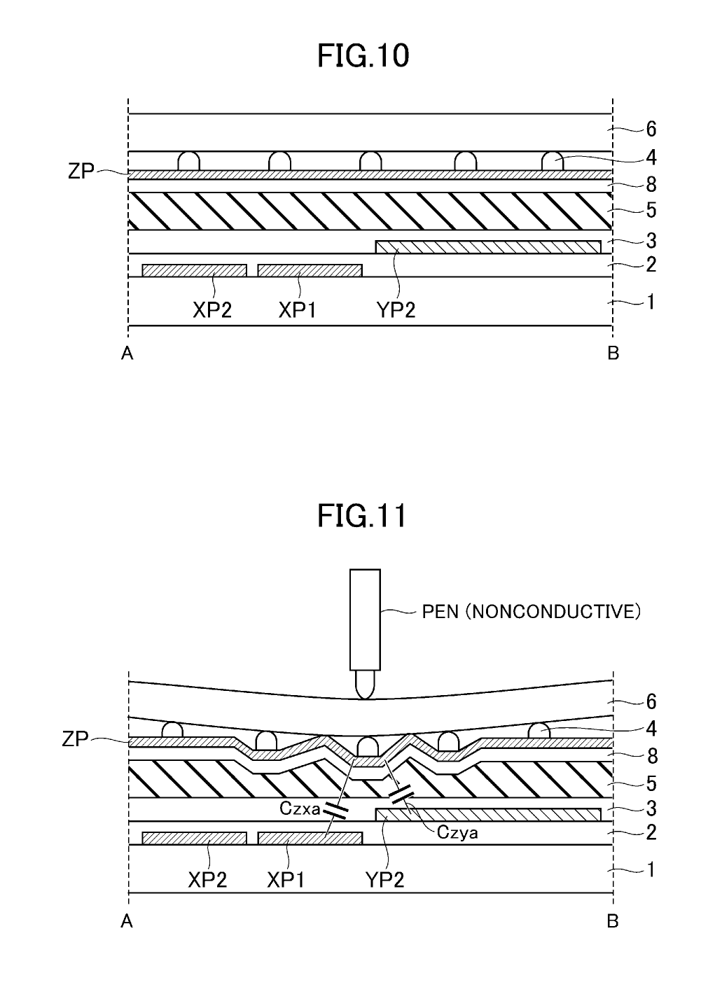

FIG. 10 is a configuration diagram of a touch panel 101 according to a fourth embodiment of the present invention, which illustrates a cross-sectional shape of the touch panel 101 taken along the line A-B of FIG. 3.

The touch panel 101 according to the fourth embodiment of the present invention has a configuration in which the X electrode (transparent conductive film) XP, the first transparent insulating film 2, the Y electrode (transparent conductive film) YP, the second transparent insulating film 3, the transparent elastic layer 5, the nonconductive layer 8, the Z electrode ZP, and the spacers 4 for providing a space with respect to the Z electrode ZP are sequentially laminated on the first transparent substrate 1, with the second transparent substrate 6 being laminated on top thereof.

The spacers 4 may be formed as dotted columnar spacers which are each made of a photo-curable resin material. The columnar spacers may preferably be formed through screen printing or the like at intervals of equal to or larger than 20 μm and equal to or smaller than 10,000 μm. The columnar spacers may be formed in any shape freely selected from, for example, a circular shape and a rectangular shape, and have a diameter falling within a range of 5 μm to 100 μm, which may preferably be in a range of 20 μm to 50 μm.

The fourth embodiment is similar to the first embodiment in terms of material and property of the other layers, and hence the description thereof is omitted herein.

Next, a capacitance change that occurs in response to a touch operation made to the touch panel 101 according to the fourth embodiment of the present invention is described with reference to FIG. 11.

FIG. 11 is a schematic view for illustrating a capacitance change that occurs in a case where nonconductive input means is used for making a touch operation, and a distance from the X electrode XP to the Z electrode ZP and a distance from the Y electrode YP to the Z electrode ZP are changed due to a pressure applied when the touch panel 101 is touched. Further, the following description may similarly be applied to a case where the distance from the X electrode XP to the Z electrode ZP and the distance from the Y electrode YP to the Z electrode ZP are changed by a pressure applied through conductive input means (such as finger).

Even in a case where a touch operation is made to the touch panel 101 according to the fourth embodiment of the present invention, similarly to the first embodiment of the present invention described with reference to FIG. 4, the distances from the Z electrode ZP to each of the X electrode XP and the Y electrode YP are reduced. Accordingly, the capacitance change at this time is expressed by Expression (3) similarly to the first embodiment.

The capacitance detection part 102 detects a capacitance of each electrode, or a capacitance change that occurs depending on whether or not a touch operation is made as expressed by Expression (3). The arithmetic control part 103 calculates the coordinates of the input when the touch operation is made, by using, as a signal component, the capacitance of each electrode or the capacitance change obtained by the capacitance detection part 102.

According to the description given above, the input coordinates may be detected based on the capacitance change that occurs when the distance from the X electrode XP to the Z electrode ZP and the distance from the Y electrode YP to the Z electrode ZP are changed due to a pressure, even when the input is made with nonconductive input means.

Further, the display device 106 and the touch panel 101 are laminated in a manner similar to that of the first embodiment of the present invention, and hence the description thereof is omitted herein.

As described above, according to the fourth embodiment of the present invention, even when a contact is made onto the touch panel 101 with nonconductive input means, a distance from the X electrode XP or from the Y electrode YP for capacitance detection to the Z electrode ZP formed thereabove is changed, to thereby generate a capacitance change, which allows the touch panel 101 to function as a capacitive coupling type touch panel capable of detecting the input coordinates.

### Fifth Embodiment

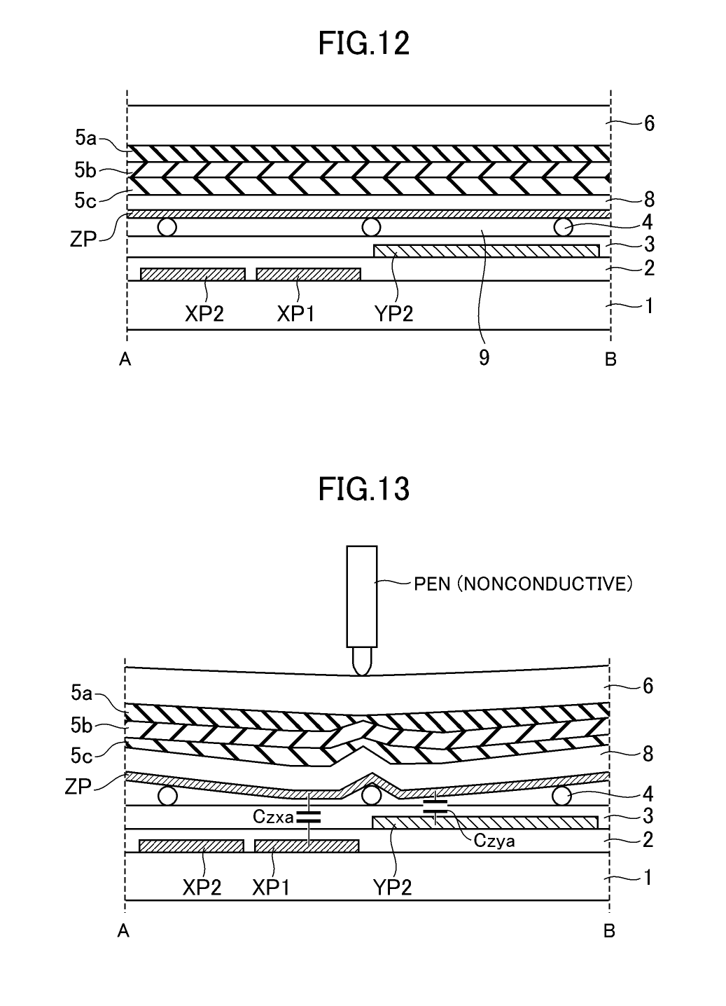

FIG. 12 is a configuration diagram of a touch panel 101 according to a fifth embodiment of the present invention, which illustrates a cross-sectional shape of the touch panel 101 taken along the line A-B of FIG. 3. The touch panel 101 according to the fifth embodiment of the present invention has a configuration in which the X electrode (transparent conductive film) XP, the first transparent insulating film 2, the Y electrode (transparent conductive film) YP, the second transparent insulating film 3, the spacers 4 for providing a space with respect to the Z electrode ZP, the Z electrode ZP, the nonconductive layer 8, and the transparent elastic layer 5 are sequentially laminated on the first transparent substrate 1, with the second transparent substrate 6 being laminated on top thereof.

The transparent elastic layer 5 has a three-layered structure which includes three layers (a transparent elastic layer 5a, a transparent elastic layer 5b, and a transparent elastic layer 5c) that are different from one another in terms of hardness and pressure-sensitive adhesive power. The transparent elastic layer 5a and the transparent elastic layer 5c each adhere to the layers adjacent thereto (the nonconductive layer 8 and the second transparent substrate 6) with sufficient adhesive power, so as to be resistant to plastic deformation and adhesive displacement even when pressure is repeatedly applied under a large load (of, for example, equal to or larger than 10 N). The transparent elastic layer 5b formed between the transparent elastic layer 5a and the transparent elastic layer 5c is not required to have adhesive power in particular, and the transparent elastic layer 5b has elasticity and is resistant to plastic deformation even when pressure is repeatedly applied under a large load (the transparent elastic layer 5b is high in rigidity than the transparent elastic layers 5a and 5c).

The transparent elastic layer 5a and the transparent elastic layer 5c may be formed of a material which is not particularly limited as long as being formed of a rubber-like elastic material having pressure-sensitive adhesive power, and may preferably be formed of a material resistant to plastic deformation even when pressure is repeatedly applied under a large load.

According to the present invention, such a material may include an acrylic pressure-sensitive adhesive material, a vinyl acetate-based pressure-sensitive adhesive material, a urethane-based pressure-sensitive adhesive material, an epoxy resin, a vinylidene chloride-based resin, a polyamide-based resin, a polyester-based resin, a synthetic rubber-based pressure-sensitive adhesive material, and a silicone-based resin. Of those, an acrylic pressure-sensitive adhesive material and a silicone-based resin, which are highly transparent, are particularly preferred. To obtain an acrylic pressure-sensitive adhesive material, one kind or a mixture of two or more kinds of alkyl (meth)acrylate, (meth)acrylic acid, and hydroxyalkyl (meth)acrylate is subjected to a known polymerization process such as a solution polymerization process, an emulsion polymerization process, a bulk polymerization process, a suspension polymerization processor or a UV polymerization process, so as to obtain an acrylic polymer, to which additives such as a tackifier and a filler may be added.

Specific examples of the alkyl (meth)acrylate include butyl (meth)acrylate, isobutyl (meth)acrylate, hexyl (meth)acrylate, 2-ethylhexyl (meth)acrylate, isooctyl (meth)acrylate, isononyl (meth)acrylate, allyl (meth)acrylate, lauryl (meth)acrylate, and stearyl (meth)acrylate.

The transparent elastic layer 5b is not particularly limited as long as being formed of a rubber-like elastic material, and may preferably be formed of a material resistant to plastic deformation even when pressure is repeatedly applied under a large load. Examples of the material include a butyl rubber, a fluorocarbon rubber, an ethylene-propylene-diene copolymer rubber (EPDM), an acrylonitrile-butadiene rubber (NBR), a chloroprene rubber (CR), a natural rubber (NR), an isoprene rubber (IR), a styrene-butadiene rubber (SBR), a butadiene rubber, an ethylene-propylene rubber, a silicone rubber, a polyurethane rubber, a polynorbornene rubber, a styrene-butadiene-styrene rubber, an epichlorohydrin rubber, a hydrogenated product of NBR, a polysulfide rubber, and a urethane rubber. One kind of the rubbers may be used alone, or two or more kinds of them may be used as a mixture. Further, similarly to the transparent elastic layer 5a and the transparent elastic layer 5c, for the transparent elastic layer 5b, an acrylic pressure-sensitive adhesive material, a vinyl acetate-based pressure-sensitive adhesive material, a urethane-based pressure-sensitive adhesive material, an epoxy resin, a vinylidene chloride-based resin, a polyamide-based resin, a polyester-based resin, a synthetic rubber-based pressure-sensitive adhesive material, or a silicone-based resin may be used. Of those, an acrylic-based pressure-sensitive adhesive material and a silicone-based resin, which are highly transparent, are particularly preferred. The transparent elastic layer 5b may be formed to have a higher degree of polymerization as compared to the transparent elastic layer 5a and the transparent elastic layer 5c, so that the transparent elastic layer 5b may be formed to be harder than the transparent elastic layer 5a and the transparent elastic layer 5c.

The transparent elastic layer 5 may preferably be formed in a film thickness of equal to or smaller than 200 μm, so as to reduce the amount of deformation that occurs when pressure is applied thereto under a large load, to thereby suppress displacement from the adjacent layers. The transparent elastic layer 5a, the transparent elastic layer 5b, and the transparent elastic layer 5c each may be formed in a film thickness falling within a range of 5 μm to 100 μm, which may preferably be equal to or smaller than 40 μm so that the transparent elastic layer 5 may be formed to have a total film thickness of about 100 μm.

FIG. 13 is a schematic view for illustrating a capacitance change that occurs in a case where nonconductive input means is used for making a touch operation, and a distance from the X electrode XP to the Z electrode ZP and a distance from the Y electrode YP to the Z electrode ZP are changed due to a pressure applied when the touch panel 101 is touched. Further, the following description may similarly be applied to a case where the distance from the X electrode XP to the Z electrode ZP and the distance from the Y electrode YP to the Z electrode ZP are changed by a pressure applied through conductive input means (such as finger).

Even in a case where a touch operation is made to the touch panel 101 according to the fifth embodiment of the present invention, similarly to the first embodiment of the present invention described with reference to FIG. 4, the distances from the Z electrode ZP to each of the X electrode XP and the Y electrode YP are reduced. Accordingly, the capacitance change at this time is expressed by Expression (3) similarly to the first embodiment.

The capacitance detection part 102 detects a capacitance of each electrode, or a capacitance change that occurs depending on whether or not a touch operation is made as expressed by Expression (3). The arithmetic control part 103 calculates the coordinates of the input when the touch operation is made, by using, as a signal component, the capacitance of each electrode or the capacitance change obtained by the capacitance detection part 102.

According to the description given above, the input coordinates may be detected based on the capacitance change that occurs when the distance from the X electrode XP to the Z electrode ZP and the distance from the Y electrode YP to the Z electrode ZP are changed due to a pressure, even when the input is made with nonconductive input means.

Further, the display device 106 and the touch panel 101 are laminated in a manner similar to that of the first embodiment of the present invention, and hence the description thereof is omitted herein.

As described above, according to the fifth embodiment, even when a contact is made onto the touch panel 101 with nonconductive input means, a distance from the X electrode XP or from the Y electrode YP for capacitance detection to the Z electrode ZP formed thereabove is changed, to thereby generate a capacitance change, which allows the touch panel 101 to function as a capacitive coupling type touch panel capable of detecting the input coordinates.

### Sixth Embodiment

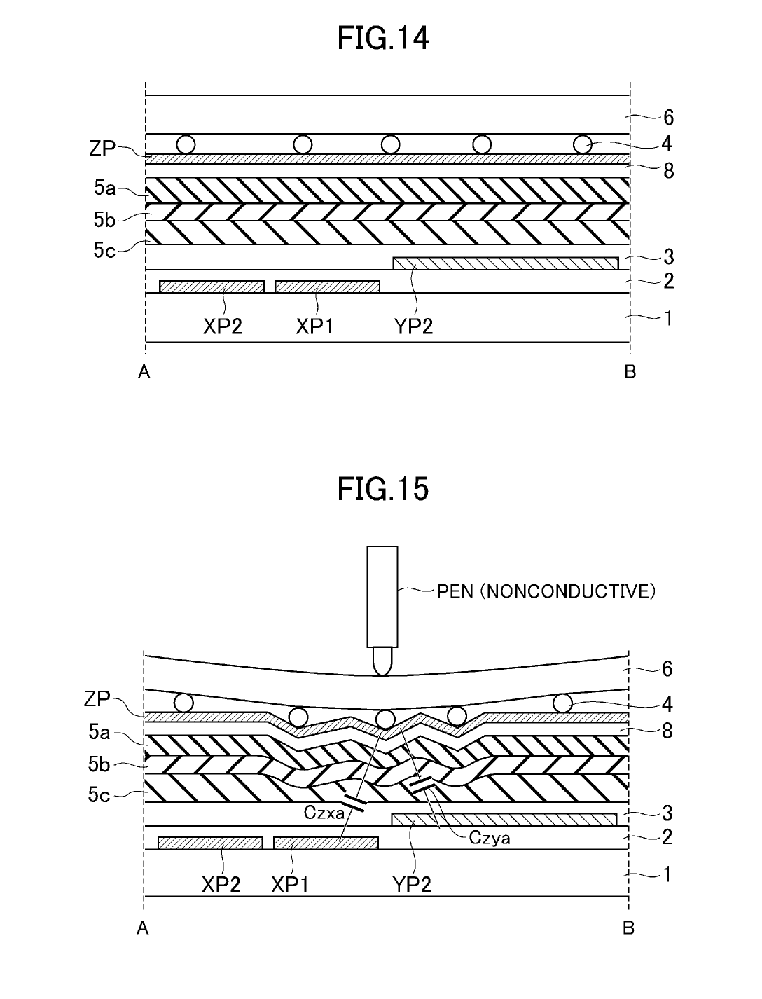

FIG. 14 is a configuration diagram of a touch panel 101 according to a sixth embodiment of the present invention, which illustrates a cross-sectional shape of the touch panel 101 taken along the line A-B of FIG. 3. The sixth embodiment is similar to the second embodiment in terms of material and property of each layer, and hence the description thereof is omitted herein.

The touch panel 101 according to the sixth embodiment of the present invention has a configuration in which the X electrode (transparent conductive film) XP, the first transparent insulating film 2, the Y electrode (transparent conductive film) YP, the second transparent insulating film 3, the transparent elastic layer 5, the nonconductive layer 8, the Z electrode ZP, and the spacers 4 for providing a space with respect to the Z electrode ZP are sequentially laminated on the first transparent substrate 1, with the second transparent substrate 6 being laminated on top thereof.

The transparent elastic layer 5 has a three-layered structure which includes three layers (the transparent elastic layer 5a, the transparent elastic layer 5b, and the transparent elastic layer 5c) that are different from one another in terms of hardness and pressure-sensitive adhesive power. The transparent elastic layer 5a and the transparent elastic layer 5c each adhere to the layers adjacent thereto (the second transparent insulating film 3 and the nonconductive layer 8) with sufficient adhesive power, so as to be resistant to plastic deformation even when pressure is repeatedly applied under a large load. The transparent elastic layer 5b formed between the transparent elastic layer 5a and the transparent elastic layer 5c is not required to have adhesive power in particular, and the transparent elastic layer 5b has elasticity and is resistant to plastic deformation even when pressure is repeatedly applied under a large load.

Next, a capacitance change that occurs in response to a touch operation made to the touch panel 101 according to the sixth embodiment of the present invention is described with reference to FIG. 15.

FIG. 15 is a schematic view for illustrating a capacitance change that occurs in a case where nonconductive input means is used for making a touch operation, and a distance from the X electrode XP to the Z electrode ZP and a distance from the Y electrode YP to the Z electrode ZP are changed due to a pressure applied when the touch panel 101 is touched. Further, the following description may similarly be applied to a case where the distance from the X electrode XP to the Z electrode ZP and the distance from the Y electrode YP to the Z electrode ZP are changed by a pressure applied through conductive input means (such as finger).

Even in a case where a touch operation is made to the touch panel 101 according to the sixth embodiment of the present invention, similarly to the second embodiment of the present invention described with reference to FIG. 7, the distances from the Z electrode ZP to each of the X electrode XP and the Y electrode YP are reduced. Accordingly, the capacitance change at this time is expressed by Expression (3) similarly to the first embodiment. The capacitance detection part 102 detects a capacitance of each electrode, or a capacitance change that occurs depending on whether or not a touch operation is made as expressed by Expression (3). The arithmetic control part 103 calculates the coordinates of the input when the touch operation is made, by using, as a signal component, the capacitance of each electrode or the capacitance change obtained by the capacitance detection part 102.

According to the description given above, the input coordinates may be detected based on the capacitance change that occurs when the distance from the X electrode XP to the Z electrode ZP and the distance from the Y electrode YP to the Z electrode ZP are changed due to a pressure, even when the input is made with nonconductive input means.

Further, the display device 106 and the touch panel 101 are laminated in a manner similar to that of the first embodiment of the present invention, and hence the description thereof is omitted herein.

As described above, according to the sixth embodiment, even when a contact is made onto the touch panel 101 with nonconductive input means, a distance from the X electrode XP or from the Y electrode YP for capacitance detection to the Z electrode ZP formed thereabove is changed, to thereby generate a capacitance change, which allows the touch panel 101 to function as a capacitive coupling type touch panel capable of detecting the input coordinates.

### Seventh Embodiment

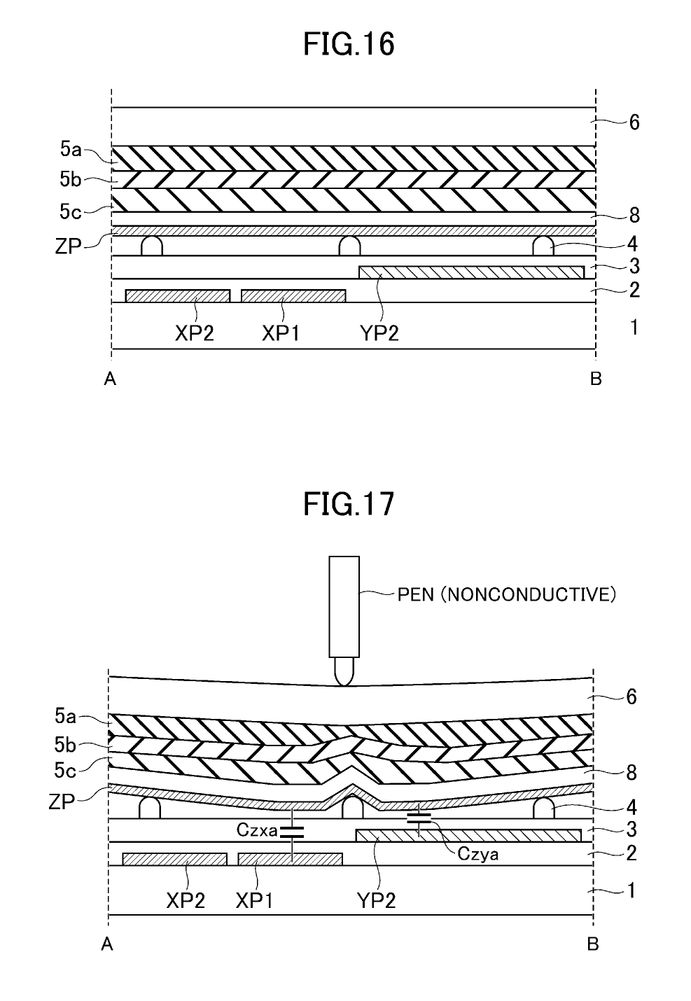

FIG. 16 is a configuration diagram of a touch panel 101 according to a seventh embodiment of the present invention, which illustrates a cross-sectional shape of the touch panel 101 taken along the line A-B of FIG. 3. The seventh embodiment is similar to the third embodiment in terms of material and property of each layer, and hence the description thereof is omitted herein.

The touch panel 101 according to the seventh embodiment of the present invention has a configuration in which the X electrode (transparent conductive film) XP, the first transparent insulating film 2, the Y electrode (transparent conductive film) YP, the second transparent insulating film 3, the spacers 4 for providing a space with respect to the Z electrode ZP, the Z electrode ZP, the nonconductive layer 8, and the transparent elastic layer 5 are sequentially laminated on the first transparent substrate 1, with the second transparent substrate 6 being laminated on top thereof.

The transparent elastic layer 5 has a three-layered structure which includes three layers (the transparent elastic layer 5a, the transparent elastic layer 5b, and the transparent elastic layer 5c) that are different from one another in terms of hardness and pressure-sensitive adhesive power. The transparent elastic layer 5a and the transparent elastic layer 5c each adhere to the layers adjacent thereto (the nonconductive layer 8 and the second transparent substrate 6) with sufficient adhesive power, so as to be resistant to plastic deformation even when pressure is repeatedly applied under a large load. The transparent elastic layer 5b formed between the transparent elastic layer 5a and the transparent elastic layer 5c is not required to have adhesive power in particular, and the transparent elastic layer 5b has elasticity and is resistant to plastic deformation even when pressure is repeatedly applied under a large load.

Next, a capacitance change that occurs in response to a touch operation made to the touch panel 101 according to the seventh embodiment of the present invention is described with reference to FIG. 17.

FIG. 17 is a schematic view for illustrating a capacitance change that occurs in a case where nonconductive input means is used for making a touch operation, and a distance from the X electrode XP to the Z electrode ZP and a distance from the Y electrode YP to the Z electrode ZP are changed due to a pressure applied when the touch panel 101 is touched. Further, the following description may similarly be applied to a case where the distance from the X electrode XP to the Z electrode ZP and the distance from the Y electrode YP to the Z electrode ZP are changed by a pressure applied through conductive input means (such as finger).

Even in a case where a touch operation is made to the touch panel 101 according to the seventh embodiment of the present invention, similarly to the second embodiment of the present invention described with reference to FIG. 7, the distances from the Z electrode ZP to each of the X electrode XP and the Y electrode YP are reduced. Accordingly, the capacitance change at this time is expressed by Expression (3) similarly to the first embodiment. The capacitance detection part 102 detects a capacitance of each electrode, or a capacitance change that occurs depending on whether or not a touch operation is made as expressed by Expression (3). The arithmetic control part 103 calculates the coordinates of the input when the touch operation is made, by using, as a signal component, the capacitance of each electrode or the capacitance change obtained by the capacitance detection part 102.

According to the description given above, the input coordinates may be detected based on the capacitance change that occurs when the distance from the X electrode XP to the Z electrode ZP and the distance from the Y electrode YP to the Z electrode ZP are changed due to a pressure, even when the input is made with nonconductive input means.

Further, the display device 106 and the touch panel 101 are laminated in a manner similar to that of the first embodiment of the present invention, and hence the description thereof is omitted herein.

As described above, according to the seventh embodiment, even when a contact is made onto the touch panel 101 with nonconductive input means, a distance from the X electrode XP or from the Y electrode YP for capacitance detection to the Z electrode ZP formed thereabove is changed, to thereby generate a capacitance change, which allows the touch panel 101 to function as a capacitive coupling type touch panel capable of detecting the input coordinates.

### Eighth Embodiment

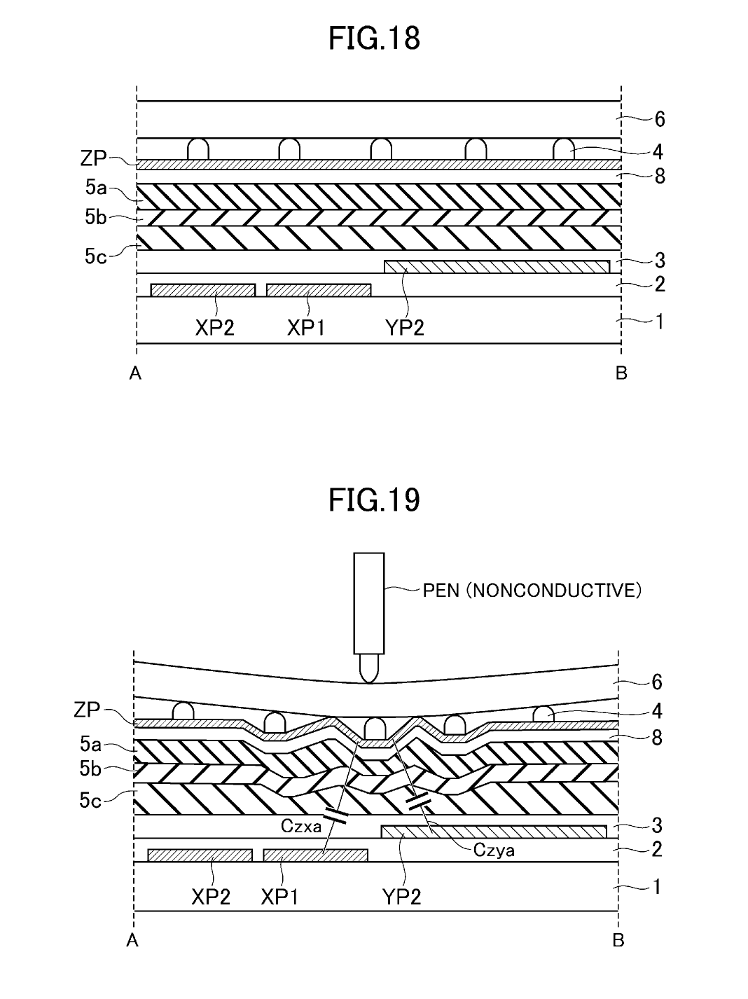

FIG. 18 is a configuration diagram of a touch panel 101 according to an eighth embodiment of the present invention, which illustrates a cross-sectional shape of the touch panel 101 taken along the line A-B of FIG. 3. The eighth embodiment is similar to the fourth embodiment in terms of material and property of each layer, and hence the description thereof is omitted herein.

The touch panel 101 according to the eighth embodiment of the present invention has a configuration in which the X electrode (transparent conductive film) XP, the first transparent insulating film 2, the Y electrode (transparent conductive film) YP, the second transparent insulating film 3, the transparent elastic layer 5, the nonconductive layer 8, the Z electrode ZP, and the spacers 4 for providing a space with respect to the Z electrode ZP are sequentially laminated on the first transparent substrate 1, with the second transparent substrate 6 being laminated on top thereof.

The transparent elastic layer 5 has a three-layered structure which includes three layers (the transparent elastic layer 5a, the transparent elastic layer 5b, and the transparent elastic layer 5c) that are different from one another in terms of hardness and pressure-sensitive adhesive power. The transparent elastic layer 5a and the transparent elastic layer 5c each adhere to the layers adjacent thereto (the second transparent insulating film 3 and the nonconductive layer 8) with sufficient adhesive power, so as to be resistant to plastic deformation even when pressure is repeatedly applied under a large load. The transparent elastic layer 5b formed between the transparent elastic layer 5a and the transparent elastic layer 5c is not required to have adhesive power in particular, and the transparent elastic layer 5b has elasticity and is resistant to plastic deformation even when pressure is repeatedly applied under a large load.

Next, a capacitance change that occurs in response to a touch operation made to the touch panel 101 according to the eighth embodiment of the present invention is described with reference to FIG. 19.

FIG. 19 is a schematic view for illustrating a capacitance change that occurs in a case where nonconductive input means is used for making a touch operation, and a distance from the X electrode XP to the Z electrode ZP and a distance from the Y electrode YP to the Z electrode ZP are changed due to a pressure applied when the touch panel 101 is touched. Further, the following description may similarly be applied to a case where the distance from the X electrode XP to the Z electrode ZP and the distance from the Y electrode YP to the Z electrode ZP are changed by a pressure applied through conductive input means (such as finger).

Even in a case where a touch operation is made to the touch panel 101 according to the eighth embodiment of the present invention, similarly to the second embodiment of the present invention described with reference to FIG. 7, the distances from the Z electrode ZP to each of the X electrode XP and the Y electrode YP are reduced. Accordingly, the capacitance change at this time is expressed by Expression (3) similarly to the first embodiment. The capacitance detection part 102 detects a capacitance of each electrode, or a capacitance change that occurs depending on whether or not a touch operation is made as expressed by Expression (3). The arithmetic control part 103 calculates the coordinates of the input when the touch operation is made, by using, as a signal component, the capacitance of each electrode or the capacitance change obtained by the capacitance detection part 102.

According to the description given above, the input coordinates may be detected based on the capacitance change that occurs when the distance from the X electrode XP to the Z electrode ZP and the distance from the Y electrode YP to the Z electrode ZP are changed due to a pressure, even when the input is made with nonconductive input means.

Further, the display device 106 and the touch panel 101 are laminated in a manner similar to that of the first embodiment of the present invention, and hence the description thereof is omitted herein.

As described above, according to the eighth embodiment, even when a contact is made onto the touch panel 101 with nonconductive input means, a distance from the X electrode XP or from the Y electrode YP for capacitance detection to the Z electrode ZP formed thereabove is changed, to thereby generate a capacitance change, which allows the touch panel 101 to function as a capacitive coupling type touch panel capable of detecting the input coordinates.

While there have been described what are at present considered to be certain embodiments of the invention, it will be understood that various modifications may be made thereto, and it is intended that the appended claims cover all such modifications as fall within the true spirit and scope of the invention.

What is claimed is:

1. A capacitive coupling type touch panel, comprising:
a plurality of coordinate detection electrodes for detecting X-Y position coordinates;
a first substrate including the plurality of coordinate detection electrodes; and
a second substrate disposed to be opposed to the first substrate,
wherein the capacitive coupling type touch panel further comprises, between the first substrate and the second substrate: a conductive layer having conductivity; a nonconductive layer supporting the conductive layer; a plurality of nonconductive spacers that are formed at intervals in a plane direction of the first substrate and the second substrate; and an elastic layer that is lower in rigidity than the first substrate, the second substrate, and the plurality of nonconductive spacers.

2. The capacitive coupling type touch panel according to claim 1,
wherein the elastic layer is formed between the second substrate and the conductive layer supported by the nonconductive layer, and
wherein the plurality of nonconductive spacers are formed between the first substrate and the conductive layer.

3. The capacitive coupling type touch panel according to claim 1,
wherein the elastic layer is formed between the first substrate and the conductive layer supported by the nonconductive layer, and
wherein the plurality of nonconductive spacers are formed between the second substrate and the conductive layer.

4. The capacitive coupling type touch panel according to claim 2,
wherein the elastic layer comprises three layers including an intermediate layer and two layers sandwiching the intermediate layer, and
wherein the intermediate layer is higher in rigidity than the two layers sandwiching the intermediate layer.

5. The capacitive coupling type touch panel according to claim 2, wherein the elastic layer is formed in a thickness that is larger than a height of each of the plurality of nonconductive spacers.

6. The capacitive coupling type touch panel according to claim 2, further comprising an insulating film formed on the plurality of coordinate detection electrodes,
wherein the plurality of nonconductive spacers are capable of contacting with the insulating film.

7. The capacitive coupling type touch panel according to claim 1, wherein the plurality of nonconductive spacers comprise beads.

8. The capacitive coupling type touch panel according to claim 1, wherein the plurality of nonconductive spacers comprise protrusions protruding from one of the first substrate side and the second substrate side.

9. The capacitive coupling type touch panel according to claim 1, wherein the plurality of nonconductive spacers are disposed at intervals of equal to or larger than 20 μm and equal to or smaller than 10,000 μm.

10. A display device with a touch panel, comprising:
a display device including a display portion; and
the capacitive coupling type touch panel according to claim 1 that is disposed on the display portion.

11. The capacitive coupling type touch panel according to claim 3,
wherein the elastic layer comprises three layers including an intermediate layer and two layers sandwiching the intermediate layer, and
wherein the intermediate layer is higher in rigidity than the two layers sandwiching the intermediate layer.

12. The capacitive coupling type touch panel according to claim 3, wherein the elastic layer is formed in a thickness that is larger than a height of each of the plurality of nonconductive spacers.

13. The capacitive coupling type touch panel according to claim 4, wherein the elastic layer is formed in a thickness that is larger than a height of each of the plurality of nonconductive spacers.

14. The capacitive coupling type touch panel according to claim 11, wherein the elastic layer is formed in a thickness that is larger than a height of each of the plurality of nonconductive spacers.
